(19) United States
(12) Patent Application Publication
(10) Pub. No.: US 2013/0117965 A1
(43) Pub. Date: May 16, 2013

(54) FLOOR PROTECTOR

(71) Applicant: THOMAS J. SIEVERS, Thousand Oaks, CA (US)

(72) Inventor: THOMAS J. SIEVERS, Thousand Oaks, CA (US)

(21) Appl. No.: 13/297,043

(22) Filed: Nov. 15, 2011

(51) Int. Cl. B60B 33/00

(52) U.S. Cl. 16/18 R

(57) ABSTRACT

A floor protector comprises: a base that includes a base cavity on the underside of the base, a buffer that is partially recessed within the base and is permanently affixed inside the base cavity, and a screw that penetrates the buffer and base to attach the floor protector to a piece of furniture. The buffer is comprised of a soft and durable material such as felt. The base and buffer may be round in shape, and the base has a larger diameter than the buffer. The floor protector may further include a base aperture and a buffer aperture through which the screw passes when attaching the floor protector to a piece of furniture. In one embodiment, the base further includes a second cavity above the base cavity wherein the second cavity houses the head of the screw when the floor protector is attached to a piece of furniture.

### FIELD OF THE INVENTION

The present invention relates to furniture pads that protect flooring from damage from the legs or other supports of various pieces of furniture. More specifically, the present invention relates to a device that is attached to the bottom surface of a piece of furniture to provide a buffer between the furniture and floor surface to prevent damage, scratches, and gouges to the flooring.

### BACKGROUND

It is often a challenge to move heavy furniture across hard floor surfaces made of hardwood, laminate, concrete, ceramic tile, or natural stone such as travertine, marble, or granite without causing damage to the flooring. Each of these types of floors present a unique set of problems, and certain types of damage caused by moving furniture may be irreparable.

For instance, it is difficult to protect hardwood flooring or laminate flooring (that is fashioned to look like hardwood flooring) from scratches and gouges. Hardwood flooring that is scratched or gouged not only looks displeasing aesthetically, but can actually damage the overall integrity of the flooring. If a plank is gouged too deeply, it may be necessary to replace the whole plank, and sometimes the entire floor needs to be replaced if the damage is extensive or a specific variety of flooring has been discontinued from the market. It can also be a very time consuming and costly measure to have the entire floor sanded and refinished. If laminate or engineered wood flooring is gouged or severely scratched, sometimes the only option is to replace planks or even replace the whole area of flooring. Sanding and refinishing is not a viable option for engineered wood flooring, which is made with a nominal top layer of real wood that either has limited sanding capabilities or may be too thin to be sanded at all.

The topcoat finishes of concrete or natural stone floors may also be scratched and scuffed from sliding heavy furniture across the surface. Reapplied or touchup finishes to the damaged area may not match the surrounding floor surface. Also, if the concrete or natural stone surface is severely gouged, the damaged portion of the floor cannot be replaced unless it is comprised of replaceable tiled portions or slabs, and attempts to repair and conceal such damage are often unsuccessful.

### Drawbacks and Potential Improvements

There is therefore a need in the art for a device that effectively shields hard floor surfaces from damage. An effective floor protector device would offer a soft and sufficiently thick material to act as a buffer between the floor surface and the furniture to prevent scratches and gouges, and it would offer a more durable design to prevent the device or its components from detaching from the furniture to which it is attached.

The products currently on the market intended to prevent damage to floors caused by furniture do not provide an effective and permanent solution to protect floors. For example, some floor pad products cannot be permanently attached to a piece of furniture and are intended for use only when the user must move furniture such as during periodic cleanings. These products are difficult to use for those who cannot lift heavy objects. Placing the floor protector pads underneath heavy or large pieces of furniture is typically a two-person task, with one person tilting or lifting the furniture while the other person slides the pad in place. Not only is this inconvenient and impossible for some individuals, but lifting or tilting is not ideal for certain types of furniture such as cabinets that contain breakable and valuable items. Additionally, these non-adhering products can easily slip out from underneath the furniture while the furniture is being moved since the non-stick gripping component may not sufficiently grip extremely heavy, large, or unusually shaped pieces of furniture.

Other floor protector products are made of flimsy plastic sliders that are attached to the bottom of furniture by tacks or adhesives, which easily become loose over time or from minor movement. The buffer component of such products does not offer adequate protection and often wears out with time since they are usually made of inadequate materials that compress with the weight of the furniture as these materials are not sufficiently thick, dense, and durable. Due to the inadequate adhesives or flimsy tacks used to secure the buffer, the buffer component easily detaches exposing the floor protector's plastic and/or tack components, which can scratch the flooring surface. The buffer component has sharp or angled edges and corners that allow the buffer component to easily detach (as it can easily snag, fold over, and/or peel off) from the floor protector device while the furniture is being moved across the floor. Since these products utilize ineffective attachment methods and are insecurely constructed, they require regular replacement to assure proper protection of flooring.

### SUMMARY

The present invention is directed to a floor protector device that provides a soft and sufficiently durable material to act as a buffer between the floor surface and the furniture to prevent scratches and gouges. The floor protector device is securely constructed and designed to prevent the device or its components from detaching from the furniture to which it is attached. The present invention therefore provides a durable, permanent, and effective solution to prevent floors from damage caused by moving furniture across floor surfaces.

To achieve the foregoing and in accordance with the purposes of the present invention, the present invention is directed to a floor protector device that attaches to a piece of furniture and comprises: (a) a base that includes a base cavity on the underside of the base, (b) a buffer positioned underneath the base wherein the buffer is partially recessed within the base and is permanently affixed inside the base cavity, and (c) a screw that penetrates the buffer and the base to attach the floor protector to a piece of furniture. The base may be comprised of a sufficiently durable material such as plastic (e.g., semi-hard plastic), and the buffer may be comprised of a suitably soft and durable material such as a heavy-duty felt that reduces friction between the furniture and the floor surface to allow the furniture to slide easily and smoothly over the floor surface. The buffer may be permanently affixed to the base cavity by a strong and permanent adhesive, glue, or cement. The base and the buffer may be round in shape such as a circle or oval; and the base has a larger diameter than the buffer, which allows the buffer to be partially recessed within the base. The buffer being partially recessed within the base, being permanently affixed to the base by a strong adhesive, and having rounded edges (as opposed to angled corners and straight/sharp edges) are all features that prevent the buffer from detaching from the floor protector while furniture to which it is attached is being moved. In one variation of the invention, the base further includes a second cavity above the base cavity, and this second cavity houses the head of the screw when the floor protector is attached to a piece of furniture (i.e., when the screw is completely screwed into the base and into the piece of furniture). In another variation, the base further includes a base aperture and the buffer further includes a buffer aperture. The screw passes through the buffer aperture and the base aperture when attaching the floor protector to a piece of furniture.

In one embodiment of the present invention, a floor protector comprises: (a) a base that includes a first cavity on the underside of the base and a base aperture above the first cavity wherein the base aperture runs through the top of the base; (b) a buffer that includes a buffer aperture wherein the buffer is partially recessed within the base and is permanently affixed inside the first cavity; and (c) a screw that penetrates the buffer through the buffer aperture and penetrates the base through the base aperture to attach the floor protector to a piece of furniture. The buffer may be comprised of felt, and the buffer may be permanently affixed inside the first cavity by glue. In some variations, the base further includes a second cavity positioned above the first cavity and below the base aperture, and the second cavity houses the head of the screw when the floor protector is attached to a piece of furniture. Yet, in other variations, the base and the buffer are both circular, and the base has a larger diameter than the buffer.

In another embodiment of the present invention, a floor protector is comprised of: (a) a base that includes a first cavity on the underside of the base and a base aperture above the first cavity wherein the base aperture runs through the top of the base; (b) a buffer that includes a buffer aperture such that the buffer is partially recessed within the base and is permanently affixed inside the first cavity, and the base and the buffer are circular and the base has a larger diameter than the buffer; and (c) a screw that penetrates the buffer through the buffer aperture and penetrates the base through the base aperture to attach the floor protector to a piece of furniture. Similar to the other embodiments, the buffer may be comprised of felt, and the buffer may be permanently affixed inside the first cavity by adhesive. In certain variations of the invention, the base further includes a second cavity positioned above the first cavity and below the base aperture wherein the second cavity houses the head of the screw when the floor protector is attached to a piece of furniture.

The above description sets forth a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in further detail, it is to be understood that the invention is not limited in its application to the details of the construction and to the arrangement of the components set forth in the following description or as illustrated in the drawings. The invention is capable of other embodiments and of being practiced and carried out in various ways. Furthermore, it is to be understood that the phraseology and terminology employed herein are for the purpose of description and should not be regarded as limiting.

Other features, aspects, and advantages of the present invention will become apparent from the following description of the invention, taken in conjunction with the accompanying drawings, which illustrate, by way of example, various features of embodiments of the invention.

### BRIEF DESCRIPTION OF THE DRAWINGS

FIG. 1 illustrates a perspective view of a floor protector showing the bottom side of the floor protector in accordance with an embodiment of the present invention.

FIG. 2 illustrates a sectional view of the floor protector taken along line 2-2 of FIG. 1.

FIG. 3 illustrates an exploded view of the floor protector shown in FIG. 2.

FIG. 4 illustrates an exploded view of the floor protector shown in FIG. 1.

### DESCRIPTION OF THE INVENTION

In the following description of embodiments of the invention, reference is made to the accompanying drawings, which form a part of this application. The drawings show, by way of illustration, certain embodiments in which the invention may be practiced. It is to be understood that other embodiments may be utilized and modifications may be made without departing from the scope of the present invention. Also, it is to be understood that the phraseology and terminology employed herein are for the purpose of description and should not be regarded as limiting.

The present invention is directed to a floor protector device that attaches to the bottom of the legs, feet, or other support structures of a piece of furniture. As shown in

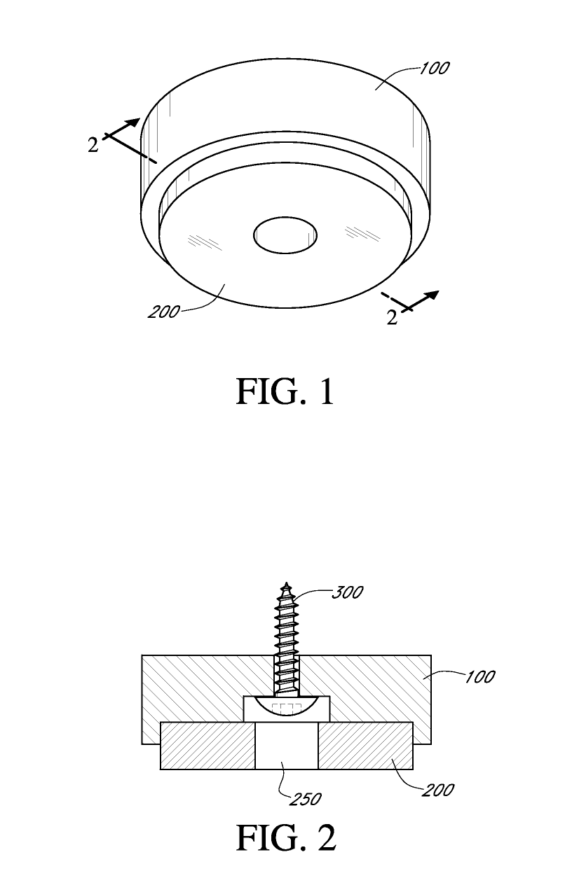

FIG. 1, which depicts a perspective view showing the floor protector's bottom side, the floor protector of the present invention generally comprises a base 100 and a buffer 200. Buffer 200 is positioned underneath base 100 such that buffer 200 is partially recessed within base 100.

FIG. 2 depicts a sectional view of the floor protector taken along line 2-2 of FIG. 1. FIG. 2 illustrates how buffer 200 is partially recessed within base 100 and partially protrudes out of base 100 to provide a buffing component between the furniture and floor surface. Since buffer 200 is partially recessed within base 100, buffer 200 is more securely attached to base 100 and is less likely to detach from the floor protector while a piece of furniture is being slid across a floor surface.

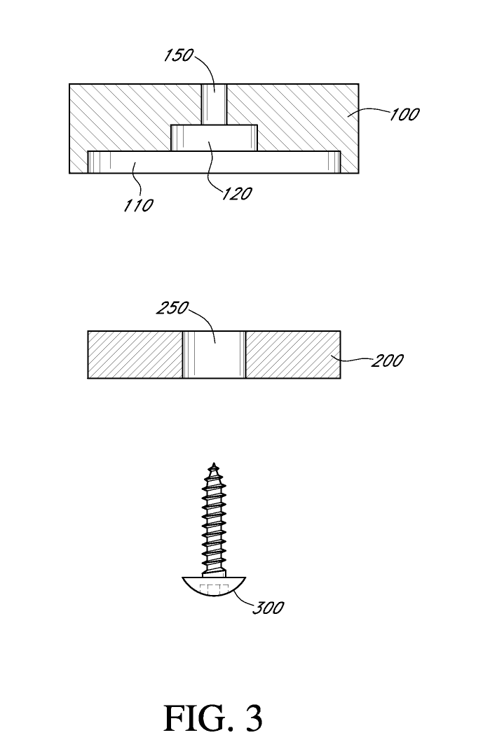

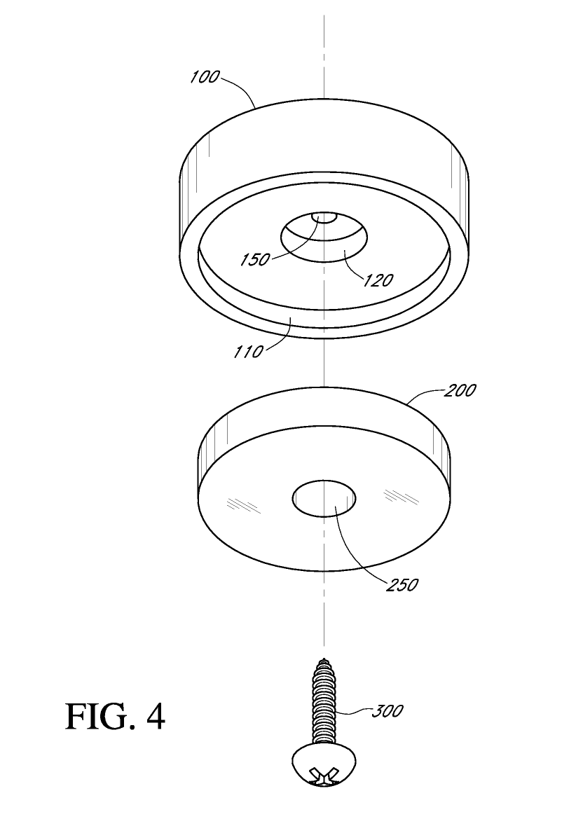

FIG. 2 illustrates an embodiment of the invention that further includes a screw 300. Therefore, in some embodiments, the floor protector is comprised of base 100 and buffer 200, and the user can simply supply his or her own screw. While in other embodiments, the floor protector is comprised of base 100, buffer 200, and screw 300. To attach the floor protector to a piece of furniture, the tip of screw 300 is drilled or screwed into buffer 200 via buffer aperture 250, into base 100 via base aperture 150 (see FIGS. 3 and 4), and then finally into the piece of furniture. As shown in FIG. 2, when the floor protector of the present invention is attached to a piece of furniture, the bottom of buffer 200 would be in direct contact with the floor surface, the tip of screw 300 would be embedded into the piece of furniture, and the head of screw 300 would be housed within second cavity 120 of base 100 (see also FIGS. 3-4).

FIG. 3 depicts an exploded view of the floor protector shown in FIG. 2, and FIG. 4 depicts an exploded view of the floor protector shown in FIG. 1. Thus, FIG. 3 depicts an exploded view of a sectional view of the components of the floor protector, and FIG. 4 depicts an exploded view of a perspective view of the components of the floor protector. Referring to the embodiments illustrated in both FIGS. 3 and 4, the floor protector is comprised of base 100, buffer 200, and screw 300. Base 100 is comprised of a first cavity 110, a second cavity 120, and a base aperture 150. Buffer 200 is comprised of buffer aperture 250.

Therefore, in the embodiment shown in FIGS. 1-4, the floor protector of the present invention is comprised of: (a) base 100 that includes first cavity 110 on the underside of base 100, (b) buffer 200 positioned underneath base 100 wherein buffer 200 is partially recessed within base 100 and buffer 200 is permanently affixed inside first cavity 110, and (c) screw 300 that penetrates buffer 200 and base 100 to attach the floor protector to the bottom side of a piece of furniture.

Base 100 may be comprised of any sufficiently durable material such as plastic (e.g., semi-hard plastic) that can support the weight of the furniture. Buffer 200 may be comprised of a suitably soft and durable material such as a heavy-duty felt that reduces friction between the furniture and the floor surface to allow the furniture to slide easily and smoothly over the floor surface. Additionally, a heavy-duty felt would not significantly compress with the weight of the furniture, as it would be more thick, dense, and durable than most felt varieties used with the ineffective floor protectors currently in the market. In alternate variations of the invention, buffer 200 may be comprised of other types of fabric materials to form a pad or cushion, rubber such as soft gripping, non-marking rubber, or combinations thereof.

Buffer 200 is permanently affixed to first cavity 110 by a strong and permanent adhesive such as an industrial-strength glue or cement. Base 100 and buffer 200 is typically round in shape such as a circle or oval, and base 100 has a larger diameter than the diameter of buffer 200, which allows buffer 200 to be partially recessed within base 100. Buffer 200 being partially recessed within base 100, being permanently affixed to base 100 by a strong and permanent adhesive, and having rounded edges (as opposed to angled corners and straight/sharp edges that can easily snag, fold over, and/or peel off) are all features that prevent buffer 200 from detaching from the floor protector while the furniture to which it is attached is being moved.

In an alternate embodiment of the invention, base 100 further includes second cavity 120 positioned above first cavity 110 and below base aperture 150 as depicted in FIGS. 3-4. As shown in FIG. 2, second cavity 120 houses the head of screw 300 when the floor protector is attached to a piece of furniture (i.e., when screw 300 is completely screwed into base 100 and the tip of screw 300 is embedded into the piece of furniture). However, in other variations of the invention, base 100 does not include second cavity 120; and in such variations, the head of screw 300 may reside in buffer aperture 250 so long as the head of screw 300 is sufficiently recessed within buffer 200 such that screw 300 does not come into contact with the floor surface.

In some embodiments of the invention, base 100 further includes base aperture 150, and buffer 200 further includes buffer aperture 250 as shown in FIGS. 2-4. In these embodiments, base aperture 150 is positioned in the center of base 100, and base aperture 150 runs through the top of base 100. Buffer aperture 250 is positioned in the center of base 200, and buffer aperture 250 runs from the bottom through the top of base 200. Screw 300 passes through buffer aperture 250 and then passes through base aperture 150 to attach the floor protector to a piece of furniture. In some variations buffer aperture 250 and base aperture 150 are merely pilot holes to help guide the proper positioning of screw 300 through buffer 200 and base 100. While in other variations of the invention, base 100 and buffer 200 do not include base aperture 150 and buffer aperture 250, respectively. In these variations of the invention, the tip of screw 300 simply penetrates base 100 and buffer 200 creating its own apertures.

Although the present invention has been described above in considerable detail with reference to certain versions thereof, other versions are possible. The components of the invention may be of any suitable shape, dimensions, and/or configuration and may even be customized to accommodate a particular type of furniture and/or type of floor; may further include structures not described hereinabove; and may be positioned at alternate suitable locations within the device without departing from the spirit and scope of the present invention.

The attached figures depicting various embodiments of the invention are primarily intended to convey the basic principles embodied in the present invention. Thus, the present invention may further include additional structures and features not illustrated in the figures.

While the description above refers to particular embodiments of the present invention, it will be understood that many modifications may be made without departing from the spirit thereof. The presently disclosed embodiments are therefore to be considered in all respects as illustrative and not restrictive.

What is claimed is:

1. A floor protector comprising:
(a) a base comprised of a base cavity on the underside of the base,
(b) a buffer underneath the base wherein the buffer is partially recessed within the base and is permanently affixed inside the base cavity, and
(c) a screw that penetrates the buffer and the base to attach the floor protector to a piece of furniture.

2. The floor protector of claim 1 wherein the base is comprised of plastic.

3. The floor protector of claim 1 wherein the buffer is comprised of felt.

4. The floor protector of claim 1 wherein the buffer is permanently affixed inside the base cavity by adhesive.

5. The floor protector of claim 1 wherein the base further comprises a second cavity above the base cavity wherein the second cavity houses the head of the screw when the floor protector is attached to a piece of furniture.

6. The floor protector of claim 1 wherein the base and the buffer are round.

7. The floor protector of claim 6 wherein the base and the buffer are circular.

8. The floor protector of claim 7 wherein the base has a larger diameter than the buffer.

9. The floor protector of claim 6 wherein the base and the buffer are oval.

10. The floor protector of claim 1 wherein the base further comprises a base aperture and the buffer further comprises a buffer aperture wherein the screw passes through the buffer aperture and the base aperture when attaching the floor protector to a piece of furniture.

11. A floor protector comprising:
(a) a base comprised of
a first cavity on the underside of the base and
a base aperture above the first cavity wherein the base aperture runs through the top of the base;
(b) a buffer comprised of
a buffer aperture wherein the buffer is partially recessed within the base and is permanently affixed inside the first cavity; and
(c) a screw that penetrates the buffer through the buffer aperture and penetrates the base through the base aperture to attach the floor protector to a piece of furniture.

12. The floor protector of claim 11 wherein the buffer is comprised of felt.

13. The floor protector of claim 11 wherein the buffer is permanently affixed inside the first cavity by glue.

14. The floor protector of claim 11 wherein the base further comprises a second cavity positioned above the first cavity and below the base aperture wherein the second cavity houses the head of the screw when the floor protector is attached to a piece of furniture.

15. The floor protector of claim 11 wherein the base and the buffer are circular.

16. The floor protector of claim 15 wherein the base has a larger diameter than the buffer.

17. A floor protector comprising:
(a) a base comprised of
a first cavity on the underside of the base and
a base aperture above the first cavity wherein the base aperture runs through the top of the base;
(b) a buffer comprised of
a buffer aperture wherein the buffer is partially recessed within the base and is permanently affixed inside the first cavity, and wherein the base and the buffer are circular and the base has a larger diameter than the buffer; and
(c) a screw that penetrates the buffer through the buffer aperture and penetrates the base through the base aperture to attach the floor protector to a piece of furniture.

18. The floor protector of claim 17 wherein the buffer is comprised of felt.

19. The floor protector of claim 17 wherein the buffer is permanently affixed inside the first cavity by adhesive.

20. The floor protector of claim 17 wherein the base further comprises a second cavity positioned above the first cavity and below the base aperture wherein the second cavity houses the head of the screw when the floor protector is attached to a piece of furniture.
